(19) United States
(12) Patent Application Publication
(10) Pub. No.: US 2025/0124416 A1
(43) Pub. Date: Apr. 17, 2025

(54) Apparatus, System, and Method for Enabling Secure Transactions with Audible Authorization

(71) Applicant: Visa International Service Association, San Francisco, CA (US)

(72) Inventor: Rahul Singhal, Bangalore (IN)

(21) Appl. No.: 18/488,135

(22) Filed: Oct. 17, 2023

(51) Int. Cl. G06Q 20/20; G06Q 20/34; G06Q 20/40

(52) U.S. Cl. CPC G06Q 20/206; G06Q 20/341; G06Q 20/40145

(57) ABSTRACT

Provided herein is a payment device including a data element containing account data and trigger data and a communication device in communication with the data element, the communication device configured to communicate the trigger data and the account data to a point-of-sale (POS) device, the trigger data configured to cause the POS device to automatically implement a modified authorization protocol. Systems and methods are also provided.

### BACKGROUND

### Field

This disclosure relates generally to payment devices and methods of using the same, and particularly an apparatus, system, and method for enabling secure transactions with audible authentication.

### Technical Considerations

In some scenarios, transactions at a point-of-sale (POS) device may benefit from audible authentication. For example, in locations where a cardholder's native language is not spoken, provision of an audible indication of the item(s) being purchased and/or the total cost, in the cardholder's native language, may increase security and prevent fraud. Similarly, for transactions entered into by visually-impaired cardholders, provision of an audible indication may increase security, and prevent fraud. Accordingly, there is a need in the art for devices, systems, and methods that can allow for increased security during transactions conducted through POS devices.

### SUMMARY

Provided herein is a payment device including a data element containing account data and trigger data and a communication device in communication with the data element, the communication device configured to communicate the trigger data and the account data to a point-of-sale (POS) device, the trigger data configured to cause the POS device to automatically implement a modified authorization protocol.

In non-limiting embodiments or aspects, the payment device is a payment card having a first surface and a second surface and the data element and the communication device are arranged on or in the card. In non-limiting embodiments or aspects, the card includes a plurality of raised indicia arranged on the first surface and/or the second surface of the card. In non-limiting embodiments or aspects, the plurality of raised indicia are braille. In non-limiting embodiments or aspects the card includes an integrated circuit chip arranged on or in the card.

In non-limiting embodiments or aspects, the payment device is an electronic payment device.

In non-limiting embodiments or aspects the trigger data includes native language data and the trigger data is configured to cause the POS device to provide an audible indication based at least in part on the native language data.

Also provided herein is a system including a payment device including a data element containing account data and trigger data and a point-of-sale (POS) device including a speaker, a communication interface, and a processor programmed or configured to automatically implement a modified transaction authorization protocol in response to receiving the trigger data by causing the speaker to output an authentication query.

In non-limiting embodiments or aspects, the payment device of the system is a payment card having a first surface and a second surface and the data element and the communication device are arranged on or in the card. In non-limiting embodiments or aspects the card includes a plurality of raised indicia arranged on the first surface and/or the second surface of the card, and the plurality of raised indicia are braille. In non-limiting embodiments or aspects the card includes an integrated circuit chip arranged on or in the card.

In non-limiting embodiments or aspects the payment device of the system is an electronic payment device.

In non-limiting embodiments or aspects the trigger data includes native language data. In non-limiting embodiments or aspects the authentication query is generated based at least in part on the native language data. In non-limiting embodiments or aspects, in the absence of the trigger data, the POS device does not implement the modified authorization protocol.

In non-limiting embodiments or aspects the processor is further programmed or configured to, following output of the authentication query, receive the account data from the payment device and complete the transaction.

In non-limiting embodiments or aspects the account data is a token. In non-limiting embodiments or aspects the processor is programmed or configured to not complete the transaction without receipt of the account data from the payment device.

Also provided herein is a computer-implemented method for processing a transaction, including receiving, with a processor at a point-of-sale (POS) device and from a payment device, trigger data, implementing, with the processor and in response to receiving the trigger data, a modified authorization protocol, receiving, with the processor and from the payment device in response to the modified authorization protocol, account data, and in response to receiving the account data and with the processor, processing the transaction.

In non-limiting embodiments the trigger data is native language data, and implementing the modified authorization protocol includes outputting, with the processor and through a speaker, an audible authentication query, and the audible authentication query is based at least in part on the native language data.

In non-limiting embodiments the modified authorization protocol includes outputting, with the processor and through the speaker, a plurality of distinct audible authorization queries.

Further non-limiting embodiments are set forth in the following numbered clauses:
Clause 1. A payment device comprising: a data element comprising account data and trigger data; and a communication device in communication with the data element, the communication device configured to communicate the trigger data and the account data to a point-of-sale (POS) device, the trigger data configured to cause the POS device to automatically implement a modified authorization protocol.
Clause 2. The payment device of clause 1, wherein the payment device comprises a payment card having a first surface and a second surface, and wherein the data element and the communication device are arranged on or in the card.
Clause 3. The payment device of clause 1 or clause 2, further comprising a plurality of raised indicia arranged on the first surface and/or the second surface of the payment card, the plurality of raised indicia comprising braille.
Clause 4. The payment device of any of clauses 1-3, further comprising an integrated circuit chip arranged on or in the payment card.
Clause 5. The payment device of any of clauses 1-4, wherein the payment device comprises an electronic payment device.
Clause 6. The payment device of any of clauses 1-5, wherein the trigger data comprises native language data, and wherein the trigger data is configured to cause the POS device to provide an audible indication based at least in part on the native language data.
Clause 7. A system comprising: a payment device comprising: a data element comprising account data and trigger data; and a point-of-sale (POS) device comprising: a speaker; a communication interface; and a processor programmed or configured to: automatically implement a modified transaction authorization protocol in response to receiving the trigger data by causing the speaker to output an authentication query.
Clause 8. The system of clause 7, wherein the payment device comprises a payment card having a first surface and a second surface, and wherein the data element and the communication device are arranged on or in the card.
Clause 9. The system of clause 7 or clause 8, further comprising a plurality of raised indicia arranged on the first surface and/or the second surface of the payment card, the plurality of raised indicia comprising braille.
Clause 10. The system of any of clauses 7-9, further comprising an integrated circuit chip arranged on or in the payment card.
Clause 11. The system of any of clauses 7-10, wherein the payment device comprises an electronic payment device.
Clause 12. The system of any of clauses 7-11, wherein the trigger data comprises native language data.
Clause 13. The system of any of clauses 7-12, wherein the authentication query is generated based at least in part on the native language data.
Clause 14. The system of any of clauses 7-13, wherein, in the absence of the trigger data, the POS device does not implement the modified authorization protocol.
Clause 15. The system of any of clauses 7-14, wherein the processor is further programmed or configured to, following output of the authentication query: receive the account data from the payment device; and complete the transaction.
Clause 16. The system of any of clauses 7-15, wherein the account data comprises a token.
Clause 17. The system of any of clauses 7-16, wherein the processor is programmed or configured to not complete the transaction without receipt of the account data from the payment device.
Clause 18. A computer-implemented method for processing a transaction, comprising: receiving, with a processor at a point-of-sale (POS) device and from a payment device, trigger data; implementing, with the processor and in response to receiving the trigger data, a modified authorization protocol; receiving, with the processor and from the payment device in response to the modified authorization protocol, account data; and in response to receiving the account data and with the processor, processing the transaction.
Clause 19. The computer-implemented method of clause 18, wherein the account data comprises a token.
Clause 20. The computer-implemented method of clause 18 or clause 19, wherein the trigger data comprises native language data, and wherein implementing the modified authorization protocol comprises outputting, with the processor and through a speaker, an audible authentication query, wherein the audible authentication query is based at least in part on the native language data.
Clause 21. The computer-implemented method of any of clauses 18-20, wherein the modified authorization protocol comprises outputting, with the processor and through the speaker, a plurality of distinct audible authorization queries.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments that are illustrated in the accompanying schematic figures, in which:

FIG. 1 is a diagram of a system for enabling secure transactions with audible authorization according to non-limiting embodiments or aspects;

FIG. 2 is a schematic diagram of example components of one or more devices of FIG. 1, according to some non-limiting embodiments as described herein; and

FIG. 3 is a process diagram of non-limiting embodiments or aspects of a method for authorizing a transaction.

### DETAILED DESCRIPTION

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second units. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction service provider” includes “transaction processing system,” which may refer to one or more computer systems operated by or on behalf of a transaction service provider, such as a transaction processing server executing one or more software applications. A transaction processing server may include at least one processor and, in some non-limiting embodiments or aspects, may be operated by or on behalf of a transaction service provider.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer institution” includes “acquirer institution system,” which may refer to one or more computing devices operated by or on behalf of an acquirer institution, such as a server computer executing one or more software applications.

As used herein, the term “issuer institution” may refer to one or more entities, such as a bank, that provides accounts to customers for conducting payment transactions, such as initiating credit and/or debit payments. For example, an issuer institution may provide an account identifier, such as a primary account number (PAN), to a customer that uniquely identifies one or more accounts associated with that customer. The account identifier may be embodied on a physical financial instrument, such as a payment card, and/or may be electronic and used for electronic payments. As used herein, the term “account identifier” may include one or more PANs, tokens, or other identifiers associated with a customer account. An account identifier may be directly or indirectly associated with an issuer institution, such that an account identifier may be a token that maps to a PAN or other type of account identifier. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifiers in one or more databases such that they can be used to conduct a transaction without directly using the original account identifier. In some examples, an original account identifier, such as a PAN, may be associated with a plurality of tokens for different individuals or purposes. An issuer institution may be associated with a bank identification number (BIN) or other unique identifier that uniquely identifies it among other issuer institutions. The terms “issuer institution,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In some non-limiting embodiments, the payment device may include volatile or non-volatile memory to store information (e.g., an account identifier, a name of the account holder, and/or the like).

Reference to any component using the indefinite article “a” or the phrase “at least one” may refer to a previously-recited component recited as performing or being involved in a previous step or function, a different component, and/or a combination of components. For example, as used in the specification and the claims, a first processor or at least one processor that is recited as performing a first step or function may refer to the same or different processor recited as performing a second step or function.

Provided herein are devices, systems, and methods for providing increased security during transaction processing. Such increased security may be provided through receipt, by a point-of-sale (POS) device, of trigger data from a user's payment device. Receipt of this trigger data may result in initiation of a modified authorization protocol, which may include audible authentication requiring additional input from the user to authorize the transaction. This authentication may take multiple forms, and may include a plurality of queries, to provide varying levels of security.

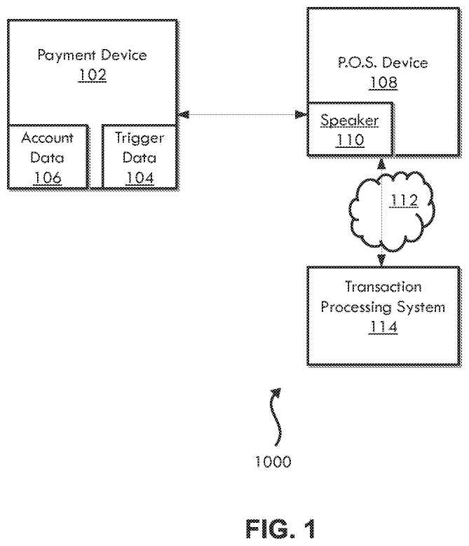

Turning to FIG. 1, shown is a system 1000 including a payment device 102 as described herein, a POS device 108 as described herein, a transaction processing system 114 as described herein, and a network 112. While a transaction processing system 114 is exemplified in FIG. 1, those of skill will appreciate that a POS device may communicate a transaction request to an acquirer institution, issuer institution, and/or a transaction service provider. Components of system 1000 may communicate through network 112, though in non-limiting embodiments, POS device 108 communicates with payment device 102 through NFC or another wireless communication protocol, and with transaction processing system 114 through network 112 (e.g., a public or private network).

In non-limiting embodiments, payment device 102 is a payment card, and may be formed out of any suitable material, such as a plastic, metal, and/or combinations thereof. In non-limiting embodiments, payment device 102 is formed of a polymer including at least polyvinyl chloride acetate. In non-limiting embodiments, payment device 102 is formed of a metal, including one or more of stainless steel, aluminum, titanium, and combinations thereof. In non-limiting embodiments, payment device 102 is a payment card, for example a card including a data element, such as a secure element, which may have stored thereon account data, such as a PAN (e.g., a PAN associated with a payment device 102) and/or a token associated with such a PAN, and/or trigger data. In non-limiting embodiments, payment device 102 includes a secure element and an integrated circuit chip, and the secure element and/or integrated circuit chip may have stored thereon a PAN (e.g., a PAN associated with a payment device 102) and/or a token associated with such a PAN, and/or trigger data. In non-limiting embodiments, payment device 102 includes therein one or more raised indicia, which may be configured as a tactile reading system, such as Braille. For example, the raised indicia may be numbers, letters, symbols, and/or the like.

In non-limiting embodiments, payment device 102 may be a mobile device, such as a smartphone, with an electronic wallet application. In non-limiting embodiments, mobile device may have stored thereon account data, such as a PAN (e.g., a PAN associated with a payment device 102) and/or a token associated with such a PAN, and/or trigger data.

As shown in FIG. 1, payment device 102 may include one or more data elements that may include trigger data 104 and account data 106. Trigger data 104 may include any data configured to trigger POS device 108 to implement a modified authorization protocol, as described herein. In non-limiting embodiments, trigger data 104 includes native language data. For example, trigger data may include one or more predetermined fields and/or values that, when detected by the POS device 108, cause the POS device 108 to implement a modified authorization protocol based on logic (e.g., programmatic logic) executed by the POS device 108. Account data 106 may include any account identifier as described herein. In non-limiting embodiments, account data 106 includes a token, which may be linked to a PAN associated with the payment device 102 user in a token vault and/or the like.

With continuing reference to FIG. 1, as a user of payment device 102 initiates a transaction and brings payment device 102 within range of POS device 108, a communication device included with payment device 102 may establish a connection with POS device 108. In non-limiting embodiments, payment device 102 may receive a radio frequency signal from POS device 108, resulting in power (e.g. electromagnetic power from the POS device 108) being provided to non-powered components of payment device 102, allowing payment device 102 to communicate trigger data 104 and/or account data 106 to POS device 108 with a communication device via, for example, a radio frequency signal. In non-limiting embodiments, POS device 108 sends a query to payment device 102, to which payment device 102 may respond by transmitting trigger data 104 to POS device 108. In non-limiting embodiments, payment device 102 may automatically transmit trigger data 104 to POS device 108 without being queried. Upon receipt of trigger data 104, POS device 108 may be programmed or configured to automatically implement a modified authorization protocol (e.g., a secondary authorization protocol) instead of a different authorization protocol (e.g., a first or primary authorization protocol) that would be implemented without the trigger data 104. In non-limiting embodiments, the POS device 108 may be programmed or configured to implement a plurality of different authorization protocols.

In non-limiting embodiments, POS device 108 may include a speaker 110 or other device to allow for POS device to emit audio, such as an authentication query. In non-limiting embodiments, such audio may convey any useful piece of information that may allow payment device 102 user to be confident in the transaction into which they are to enter. In non-limiting embodiments, POS device 108 may emit through speaker 110 information relating to a location of the transaction, a number of items purchased, total amount of the transaction, currency to be used, and/or a name of the vendor. As described previously, in non-limiting embodiments, trigger data 104 may include native language data, which may correspond to the mother tongue (e.g., a primary language according to user preferences) of payment device 102 user. In non-limiting embodiments, audio emitted by speaker 110 is in the mother tongue of payment device 102 user.

In non-limiting embodiments, as part of the modified authorization process, POS device 108 may be programmed or configured to request further input from payment device 102 prior to processing the transaction. For example, following audio output in the form of an authentication query through speaker 110 or the like, user may be required to bring payment device 102 within range of POS device 108 to allow for further communication of trigger data 104 and/or account data 106 to POS device 108. Upon receipt of trigger data 104 and/or account data 106, POS device 108 may process the transaction, for example through communicating with transaction processing system 114. In non-limiting embodiments, payment device 102 user may selectively turn the audio authentication query on and off, for example through a mobile application (e.g., an application on payment device 102) and/or a portal associated with an entity that stores an association of trigger data and account data (e.g., an issuer, acquirer, and/or transaction service provider). In non-limiting embodiments, receipt of trigger data 106 causes POS device 108 to automatically emit the authentication query. In non-limiting embodiments, in the absence of trigger data 106, POS device 108 will not emit an authentication query.

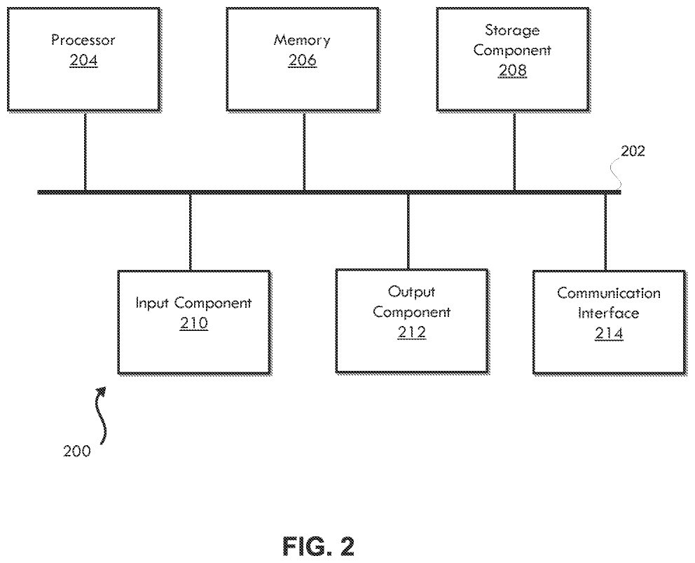

Referring now to FIG. 2, shown is a diagram of example components of a device 200 for carrying out steps of the methods described herein according to non-limiting embodiments. Device 200 may correspond to a payment device, POS device, merchant system, server computer, transaction processing system, payment gateway, acquirer institution system, user device, issuer system, and/or the like for carrying out the methods described herein. In some non-limiting embodiments, such systems or devices may include at least one device 200 and/or at least one component of device 200. The number and arrangement of components shown are provided as an example. In some non-limiting embodiments, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

As shown in FIG. 2, device 200 may include a bus 202, a processor 204, memory 206, a storage component 208, an input component 210, an output component 212, and a communication interface 214. Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a near-filed communication interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

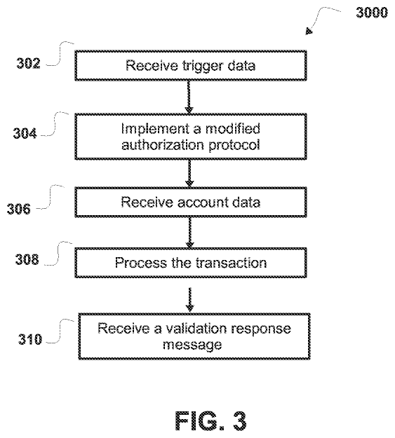

Turning to FIG. 3, shown is a flow diagram of a non-limiting embodiment of a method 3000 for authorizing and processing a transaction as described herein. One or more steps of method 3000 may be performed by a payment device, POS device, and/or transaction processing system as described herein, though it will be appreciated that other devices and/or systems may perform one or more steps in non-limiting embodiments. For example, as described above, in non-limiting embodiments POS device may communicate with one or more systems of an acquirer institution, issuer institution, and/or a transaction service provider. It will be appreciated that additional, fewer, and/or a different order of steps may be implemented in non-limiting embodiments. Further, in non-limiting embodiments each step may be automatically performed in response to a prior step being performed and/or completed.

A shown in FIG. 3, at step 302, a POS device receives trigger data from a payment device. In non-limiting embodiments, trigger data may include native language data. At step 304, upon receipt of the trigger data, POS device may automatically implement a modified authorization protocol. As part of a modified authorization protocol, a POS device may output audio, such as an authentication query as described herein. In non-limiting embodiments, audio output is provided based on the native language data. In response to audio output, at step 306 a POS device may then receive further data, for example trigger data and/or account data, from payment device, and, upon receipt of the account data, a POS device may process the transaction at step 308. In non-limiting embodiments, POS device does not process the transaction without receipt of further data, such as trigger data and/or account data, from payment device. In non-limiting embodiments, POS device may output a plurality of authentication queries, and, may require receipt of further data, such as trigger data and/or account data, in response to each of the authentication queries. In non-limiting embodiments, POS device does not process the transaction without receipt of further data, such as trigger data and/or account data, from payment device. At step 310, a POS device may receive a validation response message, which, in non-limiting embodiments, may be provided as audio output by POS device.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A payment device comprising:
a data element comprising account data and trigger data; and
a communication device in communication with the data element, the communication device configured to communicate the trigger data and the account data to a point-of-sale (POS) device, the trigger data configured to cause the POS device to automatically implement a modified authorization protocol.

2. The payment device of claim 1, wherein the payment device comprises a payment card having a first surface and a second surface, and wherein the data element and the communication device are arranged on or in the card.

3. The payment device of claim 2, further comprising a plurality of raised indicia arranged on the first surface and/or the second surface of the payment card, the plurality of raised indicia comprising braille.

4. The payment device of claim 2, further comprising an integrated circuit chip arranged on or in the payment card.

5. The payment device of claim 1, wherein the payment device comprises an electronic payment device.

6. The payment device of claim 1, wherein the trigger data comprises native language data, and wherein the trigger data is configured to cause the POS device to provide an audible indication based at least in part on the native language data.

7. A system comprising:
a payment device comprising:
a data element comprising account data and trigger data; and
a point-of-sale (POS) device comprising:
a speaker;
a communication interface; and
a processor programmed or configured to: automatically implement a modified transaction authorization protocol in response to receiving the trigger data by causing the speaker to output an authentication query.

8. The system of claim 7, wherein the payment device comprises a payment card having a first surface and a second surface, and wherein the data element and the communication device are arranged on or in the card.

9. The system of claim 8, further comprising a plurality of raised indicia arranged on the first surface and/or the second surface of the payment card, the plurality of raised indicia comprising braille.

10. The system of claim 8, further comprising an integrated circuit chip arranged on or in the payment card.

11. The system of claim 7, wherein the payment device comprises an electronic payment device.

12. The system of claim 7, wherein the trigger data comprises native language data.

13. The system of claim 12, wherein the authentication query is generated based at least in part on the native language data.

14. The system of claim 7, wherein, in the absence of the trigger data, the POS device does not implement the modified authorization protocol.

15. The system of claim 7, wherein the processor is further programmed or configured to, following output of the authentication query:
receive the account data from the payment device; and
complete the transaction.

16. The system of claim 15, wherein the account data comprises a token.

17. The system of claim 15, wherein the processor is programmed or configured to not complete the transaction without receipt of the account data from the payment device.

18. A computer-implemented method for processing a transaction, comprising:
receiving, with a processor at a point-of-sale (POS) device and from a payment device, trigger data;
implementing, with the processor and in response to receiving the trigger data, a modified authorization protocol;
receiving, with the processor and from the payment device in response to the modified authorization protocol, account data; and
in response to receiving the account data and with the processor, processing the transaction.

19. The computer-implemented method of claim 18, wherein the trigger data comprises native language data, and wherein implementing the modified authorization protocol comprises outputting, with the processor and through a speaker, an audible authentication query, wherein the audible authentication query is based at least in part on the native language data.

20. The computer-implemented method of claim 19, wherein the modified authorization protocol comprises outputting, with the processor and through the speaker, a plurality of distinct audible authorization queries.
